(19) United States
(12) Patent Application Publication
(10) Pub. No.: US 2026/0342214 A1
(43) Pub. Date: Oct. 29, 2026

(54) POWER CONVERSION UNIT

(71) Applicant: AISIN CORPORATION, Kariya (JP)

(72) Inventors: Imari IWATA, Kariya-shi (JP); Takuya HANAMURA, Kariya-shi (JP); Tomoya HIRANO, Kariya-shi (JP)

(73) Assignee: AISIN CORPORATION, Kariya (JP)

(21) Appl. No.: 19/569,519

(22) Filed: Mar. 17, 2026

(30) Foreign Application Priority Data
Mar. 19, 2025 (JP) 2025-045938

(51) Int. Cl. H02M 1/32; H02M 7/217

(52) U.S. Cl. CPC H02M 1/32; H02M 7/217

(57) ABSTRACT

A power conversion unit includes: a first terminal pair connected to a DC terminal pair of a power conversion circuit; a second terminal pair connected to a power storage device; a DC link capacitor connected to both ends of the first terminal pair; a reverse-flow prevention switch disposed between the first terminal pair and the second terminal pair, allowing a current to flow between the first terminal pair and the second terminal pair in a closed state, and interrupting at least a current flowing from the second terminal pair to the first terminal pair in an open state; a first voltage detection unit detecting an inter-terminal voltage of the first terminal pair; a second voltage detection unit detecting an inter-terminal voltage of the second terminal pair; and a control unit controlling the power conversion circuit and the reverse-flow prevention switch. The control unit can execute diagnosis processing of determining whether the reverse-flow prevention switch is normal or abnormal. In the diagnosis processing, the control unit executes at least one of ON failure determination processing of determining whether an ON failure in which the reverse-flow prevention switch is in the closed state has occurred or OFF failure determination processing of determining whether an OFF failure in which the reverse-flow prevention switch is in the open state has occurred. In the ON failure determination processing, the control unit controls the reverse-flow prevention switch to be in the open state, and determines that the ON failure has occurred in a case where any one of a difference between a first reference voltage value, which is the inter-terminal voltage of the first terminal pair in a case where the reverse-flow prevention switch is in the open state and the reverse-flow prevention switch is normal, and a first voltage detection value, which is a detection value of the first voltage detection unit, and a difference between a second reference voltage value, which is the inter-terminal voltage of the second terminal pair in a case where the reverse-flow prevention switch is in the open state and the reverse-flow prevention switch is normal, and a second voltage detection value, which is a detection value of the second voltage detection unit, exceeds an ON failure determination value set in advance. In the OFF failure determination processing, the control unit controls the reverse-flow prevention switch to be in the closed state, and determines that the OFF failure has occurred in a case where any one of a difference between a third reference voltage value and the first voltage detection value, the third reference voltage value being the inter-terminal voltage of the first terminal pair in a case where the reverse-flow prevention switch is in the closed state and the reverse-flow prevention switch is normal, and a difference between a fourth reference voltage value and the second voltage detection value, the fourth reference voltage value being the inter-terminal voltage of the second terminal pair in a case where the reverse-flow prevention switch is in the closed state and the reverse-flow prevention switch is normal, exceeds an OFF failure determination value set in advance.

### CROSS REFERENCE TO RELATED APPLICATIONS

This application is based on and claims priority under 35 U.S.C. § 119 to Japanese Patent Application No. 2025-045938, filed on Mar. 19, 2025, the entire content of which is incorporated herein by reference.

### TECHNICAL FIELD

The present disclosure relates to a power conversion unit.

### BACKGROUND DISCUSSION

JP 2018-68035 A discloses a power system circuit including a load switch (42) between a power supply circuit (51) that generates a power supply voltage (VACCO) of a drive circuit (52) that drives a switching control signal to a power converter (10) including a DC boost converter (11) and an inverter (20) and a power storage device (auxiliary battery (95)) that supplies power to the power supply circuit (51) (the reference signs in parentheses in the background art are those of the referenced document). The power supply circuit (51) and the power storage device (95) can be electrically connected and disconnected by the load switch (42). For example, in a case where it is determined that the current flowing through the DC boost converter (11) and the inverter (20) is not within the normal range, the load switch (42) is controlled to the open state, power supply to the drive circuit (52) is interrupted, and driving of the DC boost converter (11) and the inverter (20) is stopped. By providing such a load switch (42), the safety of the power converter (10) can be secured. However, this is based on the premise that the load switch (42) is normal, and there is no mention of determining whether or not the load switch (42) itself is abnormal.

A switch such as the load switch described above can also be used to restrict unnecessary takeout of power from the power storage device. For example, in a case where a charging circuit for charging the power storage device is mounted on a device on which the power storage device is mounted, a switch can be disposed between the charging circuit and the power storage device. When the power storage device is charged from the charging circuit, the switch is controlled to be in the closed state, and the charging circuit and the power storage device are electrically connected. When the charging circuit is not in operation and does not charge the power storage device, the switch is controlled to be in the open state, whereby electrical connection between the charging circuit and the power storage device can be cut off. As a result, it is possible to prevent a current from flowing reversely from the power storage device to the charging circuit in the non-operating state and to prevent the power of the power storage device from being taken out. That is, in this case, the switch functions as a reverse-flow prevention switch. It is preferable that whether or not the switch is normal is appropriately determined.

A need thus exists for a power conversion unit which is not susceptible to the drawback mentioned above.

### SUMMARY

A power conversion unit includes:
a first terminal pair that is connected to a DC terminal pair of a power conversion circuit;
a second terminal pair that is connected to a power storage device;
a DC link capacitor that is connected to both ends of the first terminal pair;
a reverse-flow prevention switch that is disposed between the first terminal pair and the second terminal pair, allows a current to flow between the first terminal pair and the second terminal pair in a closed state, and interrupts at least a current flowing from the second terminal pair to the first terminal pair in an open state;
a first voltage detection unit that detects an inter-terminal voltage of the first terminal pair;
a second voltage detection unit that detects an inter-terminal voltage of the second terminal pair; and
a control unit that controls the power conversion circuit and the reverse-flow prevention switch,
the control unit is able to execute diagnosis processing of determining whether the reverse-flow prevention switch is normal or abnormal,
in the diagnosis processing, the control unit executes at least one of ON failure determination processing of determining whether an ON failure in which the reverse-flow prevention switch is in the closed state has occurred or OFF failure determination processing of determining whether an OFF failure in which the reverse-flow prevention switch is in the open state has occurred, in the ON failure determination processing,
the control unit controls the reverse-flow prevention switch to be in the open state, and
the control unit determines that the ON failure has occurred in a case where any one of a difference between a first reference voltage value, which is the inter-terminal voltage of the first terminal pair in a case where the reverse-flow prevention switch is in the open state and the reverse-flow prevention switch is normal, and a first voltage detection value, which is a detection value of the first voltage detection unit, and a difference between a second reference voltage value, which is the inter-terminal voltage of the second terminal pair in a case where the reverse-flow prevention switch is in the open state and the reverse-flow prevention switch is normal, and a second voltage detection value, which is a detection value of the second voltage detection unit, exceeds an ON failure determination value that is set in advance, and
in the OFF failure determination processing,
the control unit controls the reverse-flow prevention switch to be in the closed state, and
the control unit determines that the OFF failure has occurred in a case where any one of a difference between a third reference voltage value and the first voltage detection value, the third reference voltage value being the inter-terminal voltage of the first terminal pair in a case where the reverse-flow prevention switch is in the closed state and the reverse-flow prevention switch is normal, and a difference between a fourth reference voltage value and the second voltage detection value, the fourth reference voltage value being the inter-terminal voltage of the second terminal pair in a case where the reverse-flow prevention switch is in the closed state and the reverse-flow prevention switch is normal, exceeds an OFF failure determination value that is set in advance.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a schematic circuit block diagram illustrating an example of an in-vehicle circuit including a power conversion unit;

FIG. 2 is a schematic circuit block diagram illustrating an example of the power conversion unit;

FIG. 3 is a flowchart illustrating an example of diagnosis processing (a first diagram of two divided diagrams);

FIG. 4 is a flowchart illustrating the example of the diagnosis processing (a second diagram of the two divided diagrams);

FIG. 5 is a flowchart illustrating an example of first preprocessing and second preprocessing in FIG. 4; and

FIG. 6 is a flowchart illustrating another example of the first preprocessing and the second preprocessing in FIG. 4.

### DETAILED DESCRIPTION

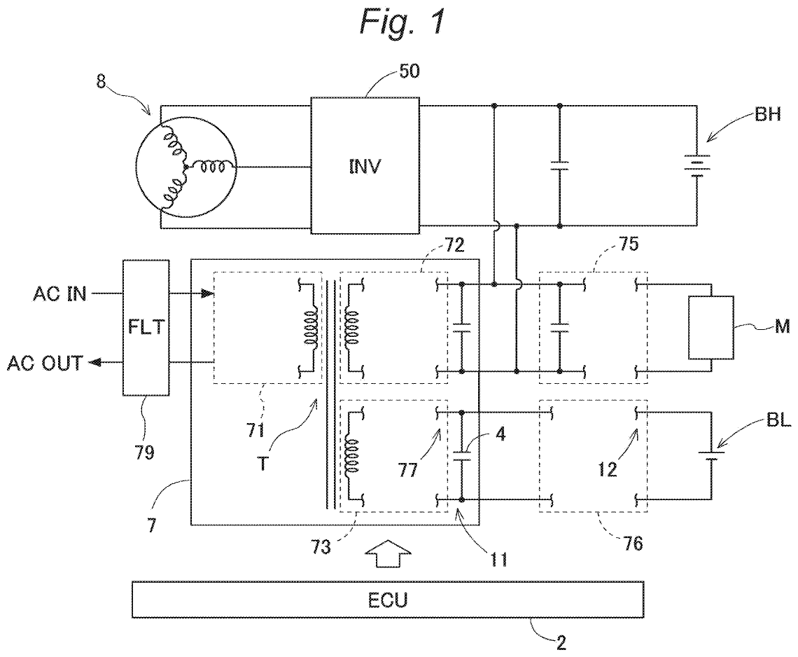

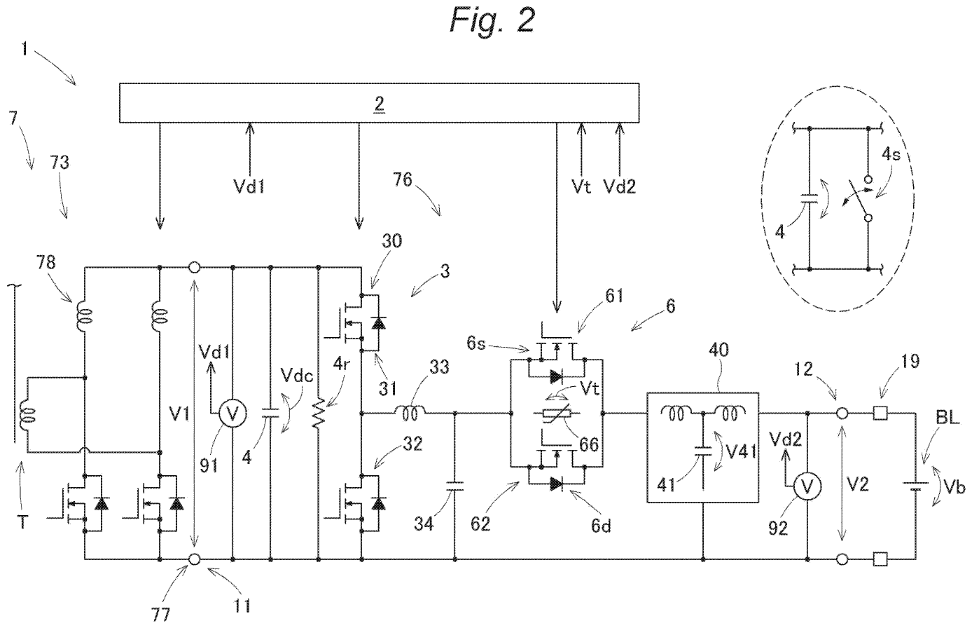

Hereinafter, an embodiment of a power conversion unit 1 will be described by exemplifying a mode used in a battery electric vehicle (BEV) or a plug-in hybrid vehicle (PHEV). The schematic circuit block diagram of FIG. 1 illustrates an example of an in-vehicle circuit including the power conversion unit 1. The schematic circuit block diagram of FIG. 2 illustrates an example of the power conversion unit 1. The in-vehicle circuit illustrated in FIG. 1 is a power electric circuit including an inverter 50 that converts electric power between an AC rotating electrical machine 8 (traction motor) serving as a driving power source of a wheel in a vehicle and a DC high-voltage battery BH, an onboard charger (OBC) that charges the high-voltage battery BH with electric power supplied from an external AC power supply (not illustrated), a DC/DC converter that steps down the voltage of electric power from the high-voltage battery BH and supplies the electric power to an in-vehicle auxiliary machine or the like, a low-voltage battery charging circuit that charges a low-voltage battery BL with electric power supplied from the high-voltage battery BH, and the like.

The rotating electrical machine 8 is electrically connected, through the inverter 50, to the high-voltage battery BH, which is a DC power supply configured by a chargeable secondary battery such as a lithium-ion battery or a power storage device such as an electric double-layer capacitor. The rated voltage of the high-voltage battery BH is, for example, about 200 volts to 800 volts. The rotating electrical machine 8 has a function as a motor (electric motor) that is supplied with electric power from the high-voltage battery BH and generates motive power, and a function as a generator that receives motive power transmitted from the wheel side and generates electric power.

In addition to the rotating electrical machine 8, which is a traction motor, the vehicle may include an auxiliary machine rotating electrical machine M that serves as a driving power source of an auxiliary machine such as a compressor of an air conditioner, an electric pump that circulates oil, a coolant, a refrigerant of an air conditioner, or the like. In a conventional vehicle using only an internal combustion engine as a driving power source of wheels, the internal combustion engine constantly operates due to idling or the like even when the vehicle is stopped (when the wheel is not rotating), and the compressor and the pump can be operated by motive power of the internal combustion engine. However, the traction motor often stops when the vehicle is stopped, and it is difficult to operate the compressor and the pump by the motive power of the traction motor. In addition, even in a case where motive power can be used by providing a clutch or the like that connects and disconnects the power transmission path to the wheels, driving the traction motor more than necessary causes a decrease in energy efficiency of the vehicle. In addition, in a conventional vehicle using only an internal combustion engine as a driving power source of wheels, exhaust heat of the internal combustion engine can be used for an air conditioner, but in a hybrid electric vehicle or a battery electric vehicle, exhaust heat cannot be expected as much as that of the internal combustion engine, temperature adjustment by a heat pump or the like is required, and output required for the compressor or the electric pump tends to increase. Therefore, the output required for the auxiliary machine rotating electrical machine M also tends to increase.

An increasing number of vehicles are configured such that in order to cause the auxiliary machine rotating electrical machine M to output a large driving force, the auxiliary machine rotating electrical machine M is also supplied with electric power from the high-voltage battery BH similarly to the traction motor. On the other hand, the output required for the traction motor increases, and the rated voltage of the high-voltage battery BH tends to be higher. In a case where the rated voltage of the high-voltage battery BH is too high for the auxiliary machine rotating electrical machine M, a voltage conversion circuit that steps down the voltage of the DC power supplied from the high-voltage battery BH may be provided. The present embodiment exemplifies a configuration including a first DC/DC converter 75 as such a voltage conversion circuit.

As described above, the rotating electrical machine 8 not only functions as a traction motor, but also functions as a generator and can charge the high-voltage battery BH. For example, in the PHEV, mechanical energy can be supplied to the rotating electrical machine 8 by motive power of the internal combustion engine or the like to cause the rotating electrical machine 8 to generate electric power, but there are few opportunities for power generation, and the high-voltage battery BH cannot be sufficiently charged in some cases. In addition, in the BEV in which only the rotating electrical machine 8 is mounted as a driving power source, only power generation by mechanical energy from wheels in inertial traveling or the like is performed, and the high-voltage battery BH cannot be sufficiently charged in many cases. In addition, also in the PHEV, there are cases where energy efficiency is better when electric power is supplied from the outside than when electric power is generated by the rotating electrical machine 8. For this reason, there is provided the onboard charger (one function of a power conversion circuit 7) that charges the high-voltage battery BH with electric power supplied from a power supply outside the vehicle in a state where the high-voltage battery BH is mounted on the vehicle.

The high-voltage battery BH is also configured to be chargeable with electric power (AC IN) supplied from an external AC power supply (not illustrated) such as an AC commercial power supply with a rated voltage of, for example, about 100 volts to 240 volts. Therefore, the high-voltage battery BH is configured to be connectable to the external AC power supply through the power conversion circuit 7 including the onboard charger.

In recent years, it has been proposed to use a battery mounted on a battery electric vehicle or a hybrid electric vehicle as an emergency power supply at the time of a disaster or the like. In the present embodiment, the power conversion circuit 7 has a function of supplying AC power (AC OUT) of a commercial frequency from the high-voltage battery BH in addition to a function of charging the high-voltage battery BH. Of course, the power conversion circuit 7 may have only a charging function.

The power conversion circuit 7 of the present embodiment includes a dual active bridge (DAB) circuit including a transformer T, and converts AC power (AC IN) supplied from the external AC power supply side into first DC power and second DC power. When viewed from the AC side, the transformer T includes a primary-side coil and two secondary-side coils. Note that the two secondary-side coils may be referred to as a secondary coil and a tertiary coil, respectively. For example, a full bridge circuit including a switching element is connected to the primary-side coil to form a primary-side circuit 71. Similarly, a full bridge circuit is connected to the first secondary-side coil (secondary coil) to form a first secondary-side circuit (secondary-side circuit 72), and a full bridge circuit is connected to the second secondary-side coil (tertiary coil) to form a second secondary-side circuit (tertiary-side circuit 73).

The secondary-side circuit 72 generates first DC power for charging the high-voltage battery BH. An output portion of the secondary-side circuit 72 includes a smoothing capacitor that smooths the voltage of the first DC power. The tertiary-side circuit 73 generates second DC power having a voltage lower than that of the first DC power. An output portion of the tertiary-side circuit 73 is provided with a smoothing capacitor (corresponding to a DC link capacitor 4 in the power conversion unit 1 described with reference to FIG. 2) that smooths the voltage of the second DC power.

As illustrated in FIG. 1, the vehicle includes the low-voltage battery BL having a rated voltage lower than that of the high-voltage battery BH in addition to the high-voltage battery BH. The rated power supply voltage of the low-voltage battery BL is, for example, about 12 to 50 volts. In a conventional vehicle using only an internal combustion engine as a driving power source of wheels, such a low-voltage battery BL is charged with electric power generated by an alternator using motive power of the internal combustion engine. In the vehicle of the present embodiment including the high-voltage battery BH, the low-voltage battery BL can be charged with electric power supplied from the high-voltage battery BH. The low-voltage battery BL can be charged from the high-voltage battery BH through the secondary-side circuit 72, the transformer T, and the tertiary-side circuit 73. In the circuit configuration, the low-voltage battery BL can also be charged from the external AC power supply through the primary-side circuit 71, the transformer T, and the tertiary-side circuit 73. The present embodiment exemplifies a mode in which a second DC/DC converter 76 (chopper circuit 3 described later with reference to FIG. 2) is provided as a voltage conversion circuit that further steps down the voltage of the second DC power. Note that the low-voltage battery BL may be, for example, a lead-acid battery similarly to a conventional vehicle using an internal combustion engine as a driving power source of wheels.

In the present embodiment, as described above with reference to FIG. 1, since the power conversion circuit 7 is configured using the transformer T, insulation between the external AC power supply, the high-voltage battery BH, and the low-voltage battery BL can be secured.

The external AC power supply and the power conversion circuit 7 are connected through an electromagnetic interference (EMI) filter 79 that reduces EMI noise. Even in a case where the power conversion circuit 7 functions as a power feeding circuit, AC power (ACOUT) is output from the power conversion circuit 7 through the EMI filter 79. As described above, in the present embodiment, the power conversion circuit 7 includes the charging circuit, the power feeding circuit, and the voltage conversion circuit. The power conversion circuit 7 is not limited to this form, and may include at least one of the charging circuit, the power feeding circuit, and the voltage conversion circuit. In addition, the power conversion circuit 7 may include the inverter 50.

The rotating electrical machine 8 is driven and controlled by a rotating electrical machine control unit on the basis of a target torque of the rotating electrical machine 8 set according to a command from a vehicle control device (not illustrated) which is a host control device. The rotating electrical machine control unit performs switching control on the inverter 50 including a plurality of switching elements, and causes the inverter 50 to convert electric power between direct current and alternating current of a plurality of phases (three phases in the present embodiment). In the present embodiment, the rotating electrical machine control unit is configured as an ECU (control unit 2) together with a charging/feeding control unit that controls the power conversion circuit 7, a first voltage conversion control unit that controls the first DC/DC converter 75, a second voltage conversion control unit that controls the second DC/DC converter 76, and the like. The control unit 2 is constructed with a logic circuit such as a microcomputer as a core member, and each function of the control unit 2 is realized by cooperation of hardware such as the microcomputer and software (program).

The schematic circuit block diagram of FIG. 2 illustrates an example of the power conversion unit 1. In the present embodiment, a mode in which the power conversion unit 1 corresponds to the circuit that charges the low-voltage battery BL with electric power supplied from the high-voltage battery BH in the power electric circuit described above with reference to FIG. 1 will be described as an example.

As illustrated in FIG. 2, the power conversion unit 1 includes a first terminal pair 11 connected to a DC terminal pair 77 of the power conversion circuit 7 (here, the tertiary-side circuit 73), a second terminal pair 12 connected to the low-voltage battery BL (power storage device), the DC link capacitor 4 connected to both ends of the first terminal pair 11 (synonymous with the DC terminal pair 77), and a reverse-flow prevention switch 6 disposed between the first terminal pair 11 and the second terminal pair 12. Although not illustrated in FIG. 1, the tertiary-side circuit 73 includes a rectifier circuit 78 having a power factor correction (PFC) function, and a DC-side terminal of the rectifier circuit 78 corresponds to the DC terminal pair 77. In the present embodiment, a mode in which the chopper circuit 3 functioning as the second DC/DC converter 76 in FIG. 1 is further provided between the rectifier circuit 78 and the low-voltage battery BL is described as an example, but a mode in which the second DC/DC converter 76 (chopper circuit 3) is not provided may be used.

The reverse-flow prevention switch 6 is a switch that electrically connects the first terminal pair 11 and the second terminal pair 12 in the closed state to allow a current to flow between the first terminal pair 11 and the second terminal pair 12, and interrupts at least a current flowing from the second terminal pair 12 to the first terminal pair 11 in the open state. The reverse-flow prevention switch 6 may be configured by a switch, for example, a relay which can be electrically controlled by the control unit 2, but the present embodiment exemplifies a mode in which the reverse-flow prevention switch 6 is configured by a semiconductor switching element (power metal oxide semiconductor field effect transistor (power MOSFET) is exemplified). In many cases, since the semiconductor switching element includes a diode portion 6d in parallel to a transistor portion 6s, even in a case where the transistor portion 6s is in the OFF state, a current may flow through the diode portion 6d. In a case where the reverse-flow prevention switch 6 is configured by the semiconductor switching element as described above, the reverse-flow prevention switch 6 is a switch that allows a current to flow between the first terminal pair 11 and the second terminal pair 12 in the closed state, interrupts at least a current flowing from the second terminal pair 12 to the first terminal pair 11 in the open state, and allows a current flowing from the first terminal pair 11 to the second terminal pair 12.

In addition, the power conversion unit 1 includes a first voltage detection unit 91 that detects a first voltage V1 (synonymous with a DC link voltage Vdc, which is an inter-terminal voltage of the DC link capacitor 4), which is an inter-terminal voltage of the first terminal pair 11, and a second voltage detection unit 92 that detects a second voltage V2, which is an inter-terminal voltage of the second terminal pair 12. The above-described ECU is also included in the power conversion unit 1 as the control unit 2 that controls the power conversion unit 1. A first voltage detection value Vd1, which is a detection result obtained by the first voltage detection unit 91 and a second voltage detection value Vd2, which is a detection result obtained by the second voltage detection unit 92 are provided to the control unit 2, and the control unit 2 acquires these detection results.

The control unit 2 controls at least the power conversion circuit 7 and the reverse-flow prevention switch 6. Note that even when functioning as a control unit of the power conversion unit 1, the control unit 2 may control not only the tertiary-side circuit 73 (rectifier circuit 78) included in the power conversion unit 1 but also the secondary-side circuit 72 and the primary-side circuit 71. In a case where the power conversion unit 1 includes the chopper circuit 3 (second DC/DC converter 76), the control unit 2 also controls the chopper circuit 3.

The chopper circuit 3 includes a control leg 30 in which an upper-stage switching element 31 connected to a DC positive electrode side and a lower-stage switching element 32 connected to a DC negative electrode side are connected in series, a choke coil 33, and a storage capacitor 34. One end of the storage capacitor 34 is connected to a DC negative electrode, and the choke coil 33 is connected between the other end of the storage capacitor 34 and the midpoint of the control leg 30. The chopper circuit 3 is a bidirectional chopper, but functions as a step-down chopper in a case where electric power is supplied from the power conversion circuit 7 to the low-voltage battery BL (in a case where the low-voltage battery BL is charged). The chopper circuit 3 can function as a boost chopper in a case where electric power is supplied from the low-voltage battery BL to the power conversion circuit 7 side.

As illustrated in FIG. 2, a filter circuit 40 is provided at a connection portion between the power conversion unit 1 and the low-voltage battery BL, that is, an output portion to the low-voltage battery BL as viewed from the power conversion unit 1. The filter circuit 40 is disposed between the reverse-flow prevention switch 6 and the second terminal pair 12. As the filter circuit 40, various known forms of circuits (T-type, π-type, L-type, and the like) can be used. FIG. 2 illustrates a T-type filter. The filter circuit 40 includes at least a capacitive filter element (capacitor) serving as a capacitive load 41. In addition, the power conversion unit 1 and the low-voltage battery BL are connected to each other through a connector 19 with which the low-voltage battery BL can be attached to and detached from the power conversion unit 1. Although not illustrated, the power conversion unit 1 and the low-voltage battery BL may be connected through a switch (not illustrated) such as a relay capable of cutting off electrical connection between the power conversion unit 1 and the low-voltage battery BL. The switch is preferably disposed, for example, between the connector 19 and the low-voltage battery BL.

As illustrated in FIG. 2, a discharge resistor 4r is connected to the DC link capacitor 4 in parallel to the DC link capacitor 4. After the power conversion circuit 7 (the tertiary-side circuit 73) stops operating and no electric power is supplied from the power conversion circuit 7, the charge accumulated in the DC link capacitor 4 is discharged through the discharge resistor 4r. The resistance value of the discharge resistor 4r is often a relatively large value in consideration of a loss during normal operation. Therefore, in a case where an application for quickly discharging the DC link capacitor 4 is required, a discharge switch 4s is preferably connected in parallel to the DC link capacitor 4 instead of or in addition to the discharge resistor 4r. When the discharge switch 4s is in the closed state, both ends of the DC link capacitor 4 are short-circuited, the charge is quickly discharged, and the DC link voltage Vdc can be lowered to almost zero. Note that in a case where the chopper circuit 3 is provided as in the present embodiment, the DC link capacitor 4 can be discharged by controlling both the two switching elements (31, 32) of the control leg 30 to the ON state.

The reverse-flow prevention switch 6 is controlled to be in the closed state in a case where the low-voltage battery BL is charged from the power conversion circuit 7. As a result, electric power is supplied from the first terminal pair 11 to the second terminal pair 12, and the low-voltage battery BL can be charged. In a case where it is desired to allow a large charging current to flow, it is preferable to arrange a plurality of switches in parallel in consideration of the rated current of the single reverse-flow prevention switch 6. In the present embodiment, a mode in which the reverse-flow prevention switch 6 is configured by connecting a first switch 61 and a second switch 62 in parallel is exemplified. Of course, the reverse-flow prevention switch 6 may be configured by connecting three or more switches in parallel or may be configured by a single switch according to a required charging current.

In a case where a plurality of reverse-flow prevention switches 6 are connected in parallel, it is preferable to include at least one temperature sensor 66 that detects the temperature of the plurality of reverse-flow prevention switches 6. In the present embodiment, a mode in which a thermistor is included as the temperature sensor 66 is exemplified, and a thermistor voltage Vt, which is an inter-terminal voltage of the thermistor is provided to the control unit 2.

For example, in a case where two switches, that is, the first switch 61 and the second switch 62 are connected in parallel as in the present embodiment, one temperature sensor 66 may be provided between the first switch 61 and the second switch 62, or two temperature sensors 66, that is, one for the first switch 61 and one for the second switch 62 may be provided. Even in a case where one temperature sensor 66 is provided between the first switch 61 and the second switch 62, when a current flows through only one of the switches, the temperature of the one switch rises as compared with a case where a current flows through both the switches. Therefore, since the temperature detected by the temperature sensor 66 becomes higher, abnormality can be detected.

For example, in a case where an OFF failure (not limited to a failure in which a complete ON state (open state) is not brought about, and including a state in which a high resistance value (impedance) is maintained) to be described later occurs in one of the switches, both the function of closing the reverse-flow prevention switch 6 and the function of opening the reverse-flow prevention switch 6 can be realized by the other switch. Therefore, even if the control unit 2 executes diagnosis processing #10 to be described later, there is a possibility that it cannot be determined that the OFF failure has occurred. However, when a current flows through the reverse-flow prevention switch 6, for example, when the low-voltage battery BL is charged from the power conversion circuit 7, a current flows through only one of the switches that is normal. For this reason, the temperature of the one of the switches that is normal tends to be higher than that in a case where both switches are normal. The control unit 2 can determine that such an OFF failure has occurred on the basis of the detection result obtained by the temperature sensor 66.

Note that also in the chopper circuit 3, circuits may be arranged in parallel according to the required magnitude of the charging current. For example, the chopper circuit 3 may be duplicated by including two control legs 30, two choke coils 33, and two storage capacitors 34, and including the storage capacitors 34 at midpoints of the respective control legs 30 with the choke coils 33 interposed therebetween.

Note that in a case where the reverse-flow prevention switch 6 is configured by a semiconductor switching element, the diode portion 6d is often connected in parallel to the transistor portion 6s as described above. In the semiconductor switching element, the diode portion 6d is arranged such that the direction from the first terminal pair 11 toward the second terminal pair 12 is a forward direction. Therefore, in a case where the low-voltage battery BL is charged from the power conversion circuit 7, electric power can be supplied from the first terminal pair 11 to the second terminal pair 12 even when the reverse-flow prevention switch 6 is in the open state.

In a case where the low-voltage battery BL is not charged, the reverse-flow prevention switch 6 is controlled to the open state. As a result, the current flowing from the second terminal pair 12 side, that is, the low-voltage battery BL side to the first terminal pair 11 side is interrupted. Therefore, it is possible to suppress useless current takeout from the low-voltage battery BL. When the operation of the power conversion circuit 7 is stopped, there is no charge flowing from the power conversion circuit 7 into the DC link capacitor 4. When discharge of the DC link capacitor 4 is completed, the DC link voltage Vdc and the first voltage V1 become substantially 0 volts.

Here, when an abnormality, for example, an ON failure (not limited to a complete short circuit, and including a state in which a resistance value (impedance) is extremely low) occurs in the reverse-flow prevention switch 6, a current flows between the first terminal pair 11 and the second terminal pair 12 even when the reverse-flow prevention switch 6 is controlled to the open state. As a result, even in a case where the chopper circuit 3 is present, a current flows from the low-voltage battery BL to the DC link capacitor 4 through the choke coil 33 of the chopper circuit 3 and a freewheel diode of the upper-stage switching element 31, and the DC link capacitor 4 is charged. That is, there is a possibility that the current for charging the DC link capacitor 4 is taken out from the low-voltage battery BL and the storage amount of the low-voltage battery BL is reduced.

On the other hand, when the OFF failure (including a state in which a high resistance value (impedance) is maintained without being in the closed state) occurs in the reverse-flow prevention switch 6, for example, a current hardly flows between the first terminal pair 11 and the second terminal pair 12 even if the reverse-flow prevention switch 6 is controlled to the closed state. As in the present embodiment, in a case where the reverse-flow prevention switch 6 is a semiconductor switching element and includes the diode portion 6d, a current flows through the diode portion 6d, but the diode portion 6d also has a resistive component, and when a current flows through the diode portion 6d, a voltage drop of about 0.6 to 0.7 volts also occurs. For this reason, there is a possibility that power loss increases when the low-voltage battery BL is charged or the charging time becomes longer.

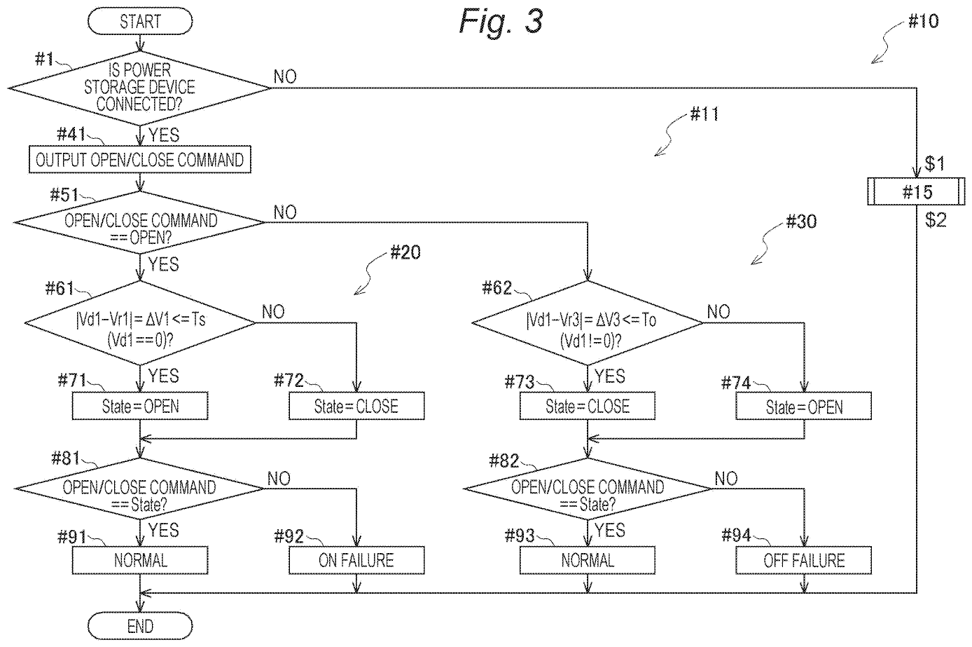

Therefore, in the present embodiment, the control unit 2 is configured to be able to execute the diagnosis processing #10 (see FIGS. 3 to 6) for determining whether the reverse-flow prevention switch 6 is normal or abnormal. The control unit 2 is configured to be able to execute, as the diagnosis processing #10, at least one of ON failure determination processing #20 of determining whether the ON failure in which the reverse-flow prevention switch 6 is in the closed state has occurred and OFF failure determination processing #30 of determining whether the OFF failure in which the reverse-flow prevention switch 6 is in the open state has occurred. In a case where the reverse-flow prevention switch 6 is configured by the switching element including the diode portion 6d as in the present embodiment, the low-voltage battery BL can be charged even if the OFF failure has occurred, so that at least the ON failure determination processing #20 is preferably executable. Of course, it is preferable that the control unit 2 can execute both the ON failure determination processing #20 and the OFF failure determination processing #30. In the present embodiment, the control unit 2 can execute both the ON failure determination processing #20 and the OFF failure determination processing #30, and in a case where an abnormality has occurred in the reverse-flow prevention switch 6, the ON failure and the OFF failure can be determined separately. Note that in a case where the reverse-flow prevention switch 6 is configured by the switching element including the diode portion 6d, a failure in which the OFF failure has occurred in both the transistor portion 6s and the diode portion 6d is referred to as an “open failure” in the present embodiment.

Hereinafter, details of the diagnosis processing #10 will be described also with reference to FIGS. 3 to 6. In the present embodiment, the control unit 2 can execute first diagnosis processing #11 in a case where the low-voltage battery BL is connected to the power conversion unit 1 and second diagnosis processing #15 in a case where the low-voltage battery BL is not connected to the power conversion unit 1. The ON failure determination processing #20 and the OFF failure determination processing #30 can be executed in the first diagnosis processing #11, and the ON failure determination processing #20 and the OFF failure determination processing #30 can be executed in the second diagnosis processing #15. The control unit 2 may execute only one of the ON failure determination processing #20 and the ON failure determination processing #30, or may execute both the ON failure determination processing #20 and the ON failure determination processing #30 by executing the exemplified flowchart twice. In addition, even in a case where the control unit 2 is scheduled to execute both the ON failure determination processing #20 and the ON failure determination processing #30, for example, in a case where it is determined that there is an abnormality in the processing executed earlier of the ON failure determination processing #20 and the ON failure determination processing #30, the execution of the processing scheduled to be executed later may be stopped.

The first diagnosis processing #11 is processing that can determine whether or not there is an abnormality in the reverse-flow prevention switch 6 in a state where the vehicle is completed as a product, and can be executed even while the power storage device (target power storage device) to which the reverse-flow prevention switch 6 to be diagnosed is connected is in use (the state of supplying electric power is a load, not during charging). On the other hand, the second diagnosis processing #15 can be executed not only in a state where the switch described above is controlled to the open state and the target power storage device is disconnected from the power conversion unit 1, but also in a case where the target power storage device is removed from the vehicle in a manufacturing process of the vehicle or during maintenance in a repair shop or the like, or in a case where a board of the power electric circuit illustrated in FIG. 1 is inspected in a manufacturing process of a component, or the like. In a case where the power storage device that supplies electric power to a control system circuit (the control unit 2 or the like) is the target power storage device, it is preferable that the second diagnosis processing #15 is executed by separately supplying electric power to the control system circuit from another power supply device.

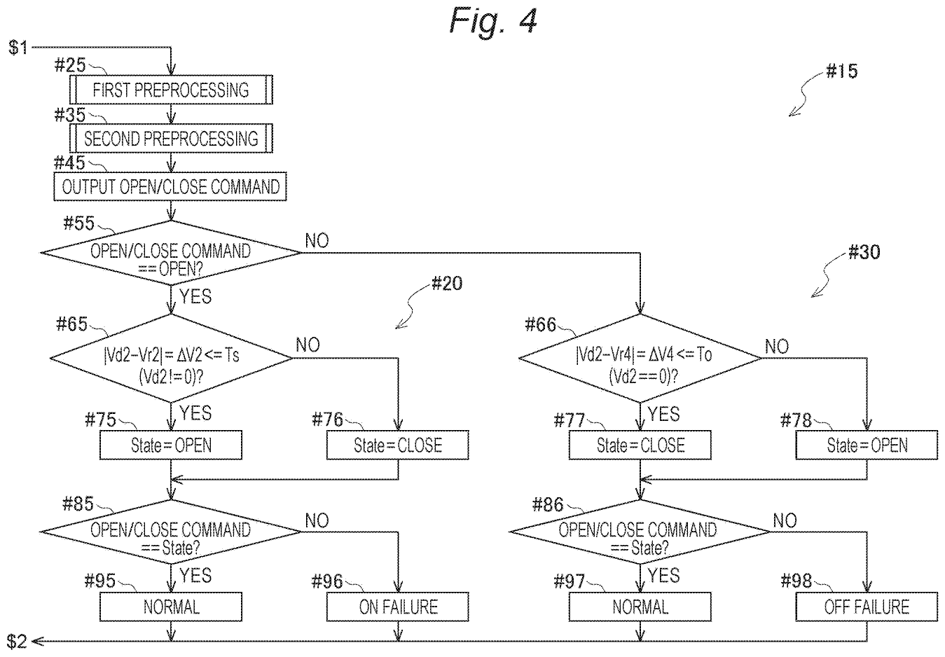

Although details will be described later, in the ON failure determination processing #20, the control unit 2 controls the reverse-flow prevention switch 6 to be in the open state, and acquires the first voltage detection value Vd1, which is a detection value of the first voltage detection unit 91 and the second voltage detection value Vd2, which is a detection value of the second voltage detection unit 92. Then, the control unit 2 determines that the ON failure has occurred in a case where any one of a “first deviation ΔV1, which is a difference between a first reference voltage value Vr1 and the first voltage detection value Vd1, the first reference voltage value Vr1 being the inter-terminal voltage (first voltage V1) of the first terminal pair 11 in a case where the reverse-flow prevention switch 6 is in the open state and the reverse-flow prevention switch 6 is normal” and a “second deviation ΔV2, which is a difference between a second reference voltage value Vr2 and the second voltage detection value Vd2, the second reference voltage value Vr2 being the inter-terminal voltage (second voltage V2) of the second terminal pair 12 in a case where the reverse-flow prevention switch 6 is in the open state and the reverse-flow prevention switch 6 is normal” exceeds an ON failure determination value Ts (See FIGS. 3 and 4) set in advance. Specifically, the control unit 2 determines that the ON failure has occurred “in a case where the first deviation ΔV1 exceeds the ON failure determination value Ts” in the first diagnosis processing #11 and “in a case where the second deviation ΔV2 exceeds the ON failure determination value Ts” in the second diagnosis processing #15. Details will be described later with reference to FIGS. 3 and 4.

In the OFF failure determination processing #30, the control unit 2 controls the reverse-flow prevention switch 6 to be in the closed state, and acquires the first voltage detection value Vd1 and the second voltage detection value Vd2. Then, the control unit 2 determines that the OFF failure has occurred in a case where any one of a “third deviation ΔV3, which is a difference between a third reference voltage value Vr3 and the first voltage detection value Vd1, the third reference voltage value Vr3 being the inter-terminal voltage (first voltage V1) of the first terminal pair 11 in a case where the reverse-flow prevention switch 6 is in the closed state and the reverse-flow prevention switch 6 is normal” and a “fourth deviation ΔV4, which is a difference between a fourth reference voltage value Vr4 and the second voltage detection value Vd2, the fourth reference voltage value Vr4 being the inter-terminal voltage (second voltage V2) of the second terminal pair 12 in a case where the reverse-flow prevention switch 6 is in the closed state and the reverse-flow prevention switch 6 is normal” exceeds an OFF failure determination value To set in advance. Specifically, the control unit 2 determines that the OFF failure has occurred “in a case where the third deviation ΔV3 exceeds the OFF failure determination value To” in the first diagnosis processing #11 and “in a case where the fourth deviation ΔV4 exceeds the OFF failure determination value To” in the second diagnosis processing #15. Details will be described later with reference to FIGS. 3 to 6.

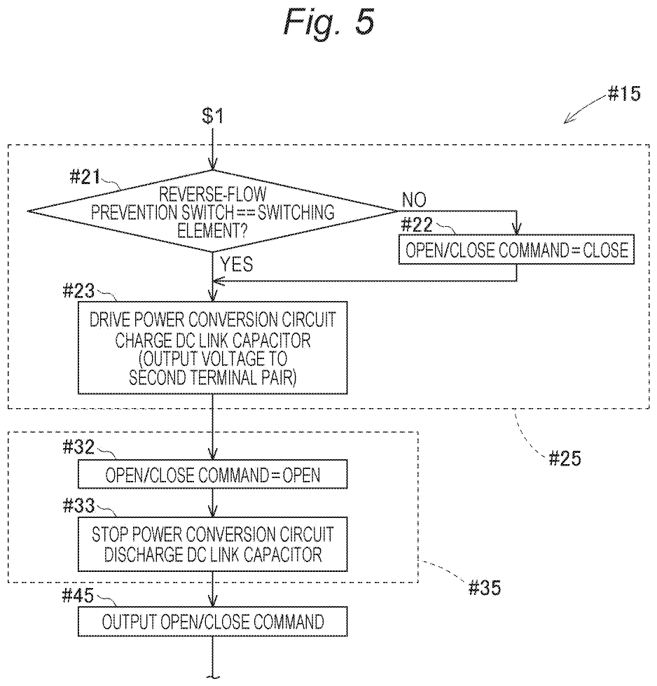

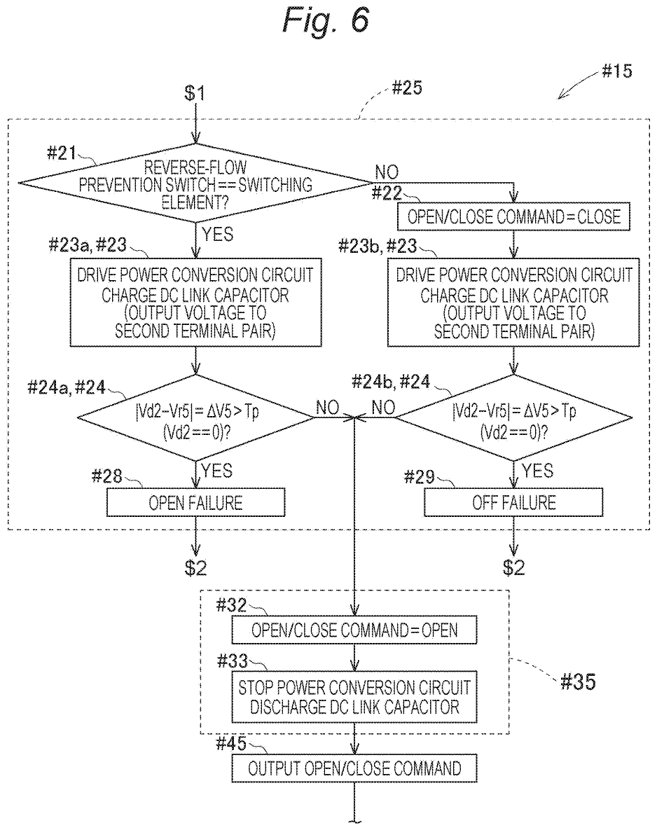

FIGS. 3 and 4 are diagrams obtained by dividing a flowchart illustrating an example of the diagnosis processing #10 into two sheets. In general, FIG. 3 illustrates the first diagnosis processing #11, and FIG. 4 illustrates the second diagnosis processing #15. FIG. 5 illustrates details of first preprocessing #25 and second preprocessing #35 illustrated in FIG. 4. FIG. 6 illustrates another embodiment of the first preprocessing #25 illustrated in FIG. 5. In the other embodiment, pre-diagnosis processing is executed as described later.

As illustrated in FIG. 3, when starting the diagnosis processing #10, the control unit 2 first determines whether or not the power storage device (here, the low-voltage battery BL) is connected to the power conversion unit 1 (#1). The control unit 2 executes the first diagnosis processing #11 in a case where the low-voltage battery BL is connected to the power conversion unit 1, and executes the second diagnosis processing #15 in a case where the low-voltage battery BL is not connected to the power conversion unit 1.

In the first diagnosis processing #11, the control unit 2 first outputs an open/close command to the reverse-flow prevention switch 6 (#41). In a case where a sufficient time has elapsed since the low-voltage battery BL is charged when the diagnosis processing #10 is executed, the DC link capacitor 4 is discharging, and the inter-terminal voltage (DC link voltage Vdc) is substantially zero. Even if a sufficient time has not elapsed since the low-voltage battery BL is charged, in a case where the power conversion unit 1 includes the discharge switch 4s described above, the control unit 2 controls the discharge switch 4s to discharge the DC link capacitor 4 before executing step #41, so that the DC link voltage Vdc can be made substantially zero. Of course, regardless of the elapsed time from when the low-voltage battery BL is charged, the control unit 2 may execute step #41 after controlling the discharge switch 4s to discharge the DC link capacitor 4.

Note that, here, in order to exemplify a mode in which the value of the “first reference voltage value Vr1” to be described later is a fixed value and is set to be substantially zero (Vr1≈0), conditions under which the value of the DC link voltage Vdc is substantially zero are indicated. However, it is also possible to detect the value of the DC link voltage Vdc by the first voltage detection unit 91 when the first diagnosis processing #11 is executed and to variably set the first reference voltage value Vr1 according to the detection result (first voltage detection value Vd1). In such a mode, the value of the DC link voltage Vdc may not be substantially zero.

Next, it is determined whether the target of the diagnosis processing #10 is the ON failure determination processing #20 or the OFF failure determination processing #30. As described above, the reverse-flow prevention switch 6 is controlled to the open state in a case where the ON failure determination processing #20 is executed. Therefore, the control unit 2 determines whether the open/close command output in step #41 is an open command (OPEN) (#51). Note that after executing step #41, the control unit 2 acquires the first voltage detection value Vd1 and the second voltage detection value Vd2 before executing step #61 or step #62 described later. Since only the first voltage detection value Vd1 is used in the first diagnosis processing #11, only the first voltage detection value Vd1 may be acquired.

When it is determined in step #51 that the open/close command is the open command (OPEN), the process proceeds to step #61, and the control unit 2 determines whether or not the first deviation ΔV1, which is a difference (absolute value) between the first voltage detection value Vd1 and the first reference voltage value Vr1 is equal to or less than the ON failure determination value Ts (#61). Since the problem is only a logical operation expression, this is synonymous with determination as to whether or not the first deviation ΔV1 exceeds the ON failure determination value Ts. As described above, the DC link capacitor 4 is discharging, and the inter-terminal voltage (DC link voltage Vdc) is zero. Therefore, the first voltage V1 is also ideally zero, and the first reference voltage value Vr1 is also zero. When the reverse-flow prevention switch 6 is normal, the first voltage detection value Vd1, which is the detection value of the first voltage V1, is also zero, so that the first deviation ΔV1 is also zero. That is, step #61 is equivalent to determining whether or not the first voltage V1 is zero. The ON failure determination value Ts may be zero, but is preferably set to a value close to zero (for example, about 0.5 to 1 volt) in consideration of a possibility that some leakage current occurs, a possibility that there is a residual charge in the DC link capacitor 4, a possibility that there is a detection error in the first voltage detection unit 91, and the like.

In a case where the determination condition in step #61 is satisfied, the control unit 2 sets the open/close state (State) of the reverse-flow prevention switch 6 to the open state (OPEN) (#71), and in a case where the determination condition in step #61 is not satisfied, the control unit 2 sets the open/close state (State) to the closed state (CLOSE) (#72). Next, the control unit 2 determines whether or not the open/close command output in step #41 matches the open/close state (State) set in step #71 or step #72 (#81). In a case where the open/close command matches the open/close state (State), the control unit 2 determines that the reverse-flow prevention switch 6 is normal (#91), and in a case where the open/close command does not match the open/close state (State), the control unit 2 determines that the reverse-flow prevention switch 6 is abnormal. In this case, since it is abnormality in a case where the open/close command is the open command, it is determined that an abnormality in which the reverse-flow prevention switch 6 is in the closed state despite the open command, that is, the “ON failure” has occurred (#92).

When it is determined in step #51 that the open/close command is the close command (CLOSE), the process proceeds to step #62, and the control unit 2 determines whether or not the third deviation ΔV3, which is a difference (absolute value) between the first voltage detection value Vd1 and the third reference voltage value Vr3, is equal to or less than the OFF failure determination value To (#62). Since the problem is only a logical operation expression, this is synonymous with determination as to whether or not the third deviation ΔV3 exceeds the OFF failure determination value To. As described above, the DC link capacitor 4 is discharging, and the inter-terminal voltage (DC link voltage Vdc) is zero. Here, when the reverse-flow prevention switch 6 is in the closed state, the DC link capacitor 4 is charged with electric power of the low-voltage battery BL. The inter-terminal voltage (DC link voltage Vdc) of the DC link capacitor 4 increases up to the inter-terminal voltage (battery voltage Vb) of the low-voltage battery BL (in a case where the forward voltage drop of the diode of the chopper circuit 3 is ignored). However, since the outflow of the charge from the low-voltage battery BL also increases, it is preferable to limit the time for maintaining the reverse-flow prevention switch 6 in the closed state. In this case, the DC link voltage Vdc has a value equal to or greater than zero and less than the battery voltage Vb. The theoretical value of the DC link voltage Vdc corresponding to the time to be in the closed state can be calculated by the time constant corresponding to the capacitance of the DC link capacitor 4.

The first voltage V1 is the DC link voltage Vdc (for example, the battery voltage Vb), and the third reference voltage value Vr3 is also the DC link voltage Vdc (for example, the battery voltage Vb). When the reverse-flow prevention switch 6 is normal, the third deviation ΔV3 is zero because the first voltage detection value Vd1, which is the detection value of the first voltage V1, is also the DC link voltage Vdc (for example, the battery voltage Vb). That is, step #62 is equivalent to determining whether or not the first voltage V1 is not zero (for example, whether or not the first voltage V1 is the battery voltage Vb). Although the OFF failure determination value To may be zero, it is preferable that the OFF failure determination value To is set to a value close to zero (for example, about 1 to 2 volts) in consideration of a voltage drop due to the wiring resistance and the circuit elements (the diode and the choke coil 33), an error in the time constant, a detection error of the first voltage detection unit 91, and the like.

In a case where the determination condition in step #62 is satisfied, the control unit 2 sets the open/close state (State) of the reverse-flow prevention switch 6 to the closed state (CLOSE) (#73), and in a case where the determination condition in step #62 is not satisfied, the control unit 2 sets the open/close state (State) to the open state (OPEN) (#74). Next, the control unit 2 determines whether or not the open/close command output in step #41 matches the open/close state (State) set in step #73 or step #74 (#82). In a case where the open/close command matches the open/close state (State), the control unit 2 determines that the reverse-flow prevention switch 6 is normal (#93), and in a case where the open/close command does not match the open/close state (State), the control unit 2 determines that the reverse-flow prevention switch 6 is abnormal. In this case, since it is abnormality in a case where the open/close command is the close command, it is determined that an abnormality in which the reverse-flow prevention switch 6 is in the open state despite the close command, that is, the “OFF failure” has occurred (#94).

When determining that the low-voltage battery BL is not connected to the power conversion unit 1 in step #1 illustrated in FIG. 3, the control unit 2 executes the second diagnosis processing #15 illustrated in FIG. 4 ($1→#15→$2). Since the low-voltage battery BL is not connected and the power conversion circuit 7 does not need to operate to charge the low-voltage battery BL, the DC link capacitor 4 is discharged. In the second diagnosis processing #15, the control unit 2 first executes the first preprocessing #25.

As illustrated in FIG. 5, in the first preprocessing #25, the control unit 2 drives the power conversion circuit 7 in a state in which the normal reverse-flow prevention switch 6 allows flow of a current from the DC link capacitor 4 to the second terminal pair 12 so as to output a voltage to the second terminal pair 12. As a result, the DC link capacitor 4 is charged (pre-charging processing #23). In a case where the reverse-flow prevention switch 6 is configured by a semiconductor switching element as in the present embodiment, the diode portion 6d is connected with the direction from the DC link capacitor 4 toward the second terminal pair 12 as the forward direction, and flow of a current from the DC link capacitor 4 toward the second terminal pair 12 is allowed. In a case where the reverse-flow prevention switch 6 does not include such a diode portion 6d, it is preferable that the reverse-flow prevention switch 6 is controlled to the closed state only while the first preprocessing #25 is executed (#22). That is, prior to the pre-charging processing #23, the control unit 2 determines whether or not the reverse-flow prevention switch 6 is a switching element (#21), and in a case where the reverse-flow prevention switch 6 is not a switching element, the control unit 2 sets the open/close command to the closed state (CLOSE) (#22).

Note that since the attribute of whether the reverse-flow prevention switch 6 to be diagnosed is a switching element or a switch is known, the first preprocessing #25 for a switching element and the first preprocessing #25 for a switch may be separately provided without providing step #21, and the program to be executed may be selected.

In a case where the chopper circuit 3 is provided as in the present embodiment, the control unit 2 controls the upper-stage switching element 31 of the control leg 30 to be in the ON state to cause the chopper circuit 3 to perform direct-coupled operation to output a voltage to the second terminal pair 12. Alternatively, the control unit 2 may cause the chopper circuit 3 to perform step-down operation to output an arbitrary voltage to the second terminal pair 12. Note that the first preprocessing #25 may be continued until the DC link voltage Vdc becomes the same value as that in the case of charging the low-voltage battery BL, or may be continued until the DC link voltage Vdc becomes any lower voltage (pre-charging voltage set in advance). The control unit 2 may control the duration of the first preprocessing #25 on the basis of the detection result (first voltage detection value Vd1) of the first voltage detection unit 91.

When the inter-terminal voltage (DC link voltage Vdc) of the DC link capacitor 4 is increased to an arbitrary voltage by the first preprocessing, the control unit 2 executes the second preprocessing #35. At the beginning of the second preprocessing #35, the control unit 2 sets the open/close command to the open state (OPEN) (#32). In a case where step #22 has not been performed, there is no change in the open/close state of the reverse-flow prevention switch 6. However, in subsequent step #33, since the reverse-flow prevention switch 6 needs to be in the open state (OPEN), it is preferable to fix the control state of the reverse-flow prevention switch 6 at the open state (OPEN) by executing step #32. The control unit 2 stops the power conversion circuit 7 and causes the DC link capacitor 4 to discharge through the discharge resistor 4r or the discharge switch 4s (#33) in a state where the normal reverse-flow prevention switch 6 does not allow flow of a current from the second terminal pair 12 to the DC link capacitor 4.

In the diode portion 6d included in the reverse-flow prevention switch 6, since the direction from the second terminal pair 12 toward the DC link capacitor 4 is the reverse direction (direction from the cathode toward the anode), current flow is not allowed. Even if the reverse-flow prevention switch 6 does not include the diode portion 6d and the reverse-flow prevention switch 6 is controlled to be in the closed state while the pre-charging processing #23 is performed in step #22, the reverse-flow prevention switch 6 is controlled to be in the open state in the first step #32 of the second preprocessing #35, so that the current flow is interrupted. Note that in a case where the chopper circuit 3 is provided as in the present embodiment, it is preferable that all the switching elements of the control leg 30 are controlled to the OFF state.

After execution of the first preprocessing #25 and the second preprocessing #35, the control unit 2 outputs an open/close command to the reverse-flow prevention switch 6 (#45). Note that, in a case where the DC link capacitor 4 is discharged through the discharge resistor 4r, it is preferable to provide a standby time until the process proceeds to step #45. Note that step #33 and step #45 may be executed in the reverse order.

Next, it is determined whether the target of the diagnosis processing #10 is the ON failure determination processing #20 or the OFF failure determination processing #30. As described above, the reverse-flow prevention switch 6 is controlled to the open state in a case where the ON failure determination processing #20 is executed. Therefore, the control unit 2 determines whether the open/close command output in step #45 is the open command (OPEN) (#55). In the second diagnosis processing #15, after executing the second preprocessing #35, the control unit 2 acquires the first voltage detection value Vd1 and the second voltage detection value Vd2 before executing step #65 or step #66 described later. Since only the second voltage detection value Vd2 is used in the second diagnosis processing #15, only the second voltage detection value Vd2 may be acquired.

When it is determined in step #55 that the open/close command is the open command (OPEN), the process proceeds to step #65, and the control unit 2 determines whether or not the second deviation ΔV2, which is a difference (absolute value) between the second voltage detection value Vd2 and the second reference voltage value Vr2 is equal to or less than the ON failure determination value Ts (#65). Since the problem is only a logical operation expression, this is synonymous with determination as to whether or not the second deviation ΔV2 exceeds the ON failure determination value Ts. Note that in a case where the ON failure determination value Ts in step #61 and the ON failure determination value Ts in step #65 are distinguished, the ON failure determination value Ts in step #61 can be referred to as a first ON failure determination value (for example, “Ts1”), and the ON failure determination value Ts in step #65 can be referred to as a second ON failure determination value (for example, “Ts2”). “Ts1” and “Ts2” may be the same value or different values.

As described above, in the first preprocessing #25, the DC link capacitor 4 is charged in a state where flow of a current from the DC link capacitor 4 to the second terminal pair 12 via the reverse-flow prevention switch 6 is allowed. In addition, as described above with reference to FIG. 2, the capacitive load 41 (for example, a capacitor) of the filter circuit 40 is connected in parallel to the second terminal pair 12. The capacitive load 41 is charged with the charge stored in the DC link capacitor 4. An inter-terminal voltage “V41” of the capacitive load 41 rises up to the DC link voltage Vdc (in a case where the upper-stage switching element 31 of the control leg 30 of the chopper circuit 3 is controlled to the ON state and the forward voltage drop of the diode portion 6d of the reverse-flow prevention switch 6 is ignored). Note that in a case where the control unit 2 causes the chopper circuit 3 to perform step-down operation, an arbitrary voltage may be output to the second terminal pair 12 to set the inter-terminal voltage “V41” of the capacitive load 41 to the arbitrary voltage.

The inter-terminal voltage (second voltage V2) of the second terminal pair 12 to which the capacitive load 41 is connected is the inter-terminal voltage “V41” (for example, the DC link voltage Vdc at the time of the first preprocessing #25) of the capacitive load 41 charged in the first preprocessing #25. Here, a value corresponding to the DC link voltage Vdc can also be used as the second reference voltage value Vr2. When the reverse-flow prevention switch 6 is normal, the second voltage detection value Vd2, which is the detection value of the second voltage V2, is also the DC link voltage Vdc at the time of the first preprocessing #25, so that the second deviation ΔV2 becomes zero. That is, step #65 is equivalent to determining whether or not the second voltage V2 is not zero (for example, whether or not the second voltage V2 is the DC link voltage Vdc in the first preprocessing #25). Although the ON failure determination value Ts may be zero, it is preferable that the ON failure determination value Ts is set to a value close to zero (for example, about 1 to 2 volts) in consideration of a voltage drop due to the wiring resistance and the circuit elements (the diode and the choke coil 33), an error in the time constant, a detection error of the first voltage detection unit 91, and the like.

In a case where the reverse-flow prevention switch 6 is not normal, that is, in a case where the reverse-flow prevention switch 6 has the ON failure, a current flows between the DC link capacitor 4 and the capacitive load 41 via the reverse-flow prevention switch 6. Since the DC link capacitor 4 is discharged in the second preprocessing #35, the charge moves from the capacitive load 41 to the DC link capacitor 4. Since the capacitance of the capacitive load 41 is smaller than the capacitance of the DC link capacitor 4, the capacitive load 41 is discharged, and the inter-terminal voltage “V41” becomes substantially zero. Therefore, in a case where the reverse-flow prevention switch 6 has the ON failure, the determination condition in step #65 is not satisfied.

In a case where the determination condition in step #65 is satisfied, the control unit 2 sets the open/close state (State) of the reverse-flow prevention switch 6 to the open state (OPEN) (#75), and in a case where the determination condition in step #65 is not satisfied, the control unit 2 sets the open/close state (State) to the closed state (CLOSE) (#76). Next, the control unit 2 determines whether or not the open/close command output in step #45 matches the open/close state (State) set in step #75 or step #76 (#85). In a case where the open/close command matches the open/close state (State), the control unit 2 determines that the reverse-flow prevention switch 6 is normal (#95), and in a case where the open/close command does not match the open/close state (State), the control unit 2 determines that the reverse-flow prevention switch 6 is abnormal. In this case, since it is abnormality in a case where the open/close command is the open command, it is determined that an abnormality in which the reverse-flow prevention switch 6 is in the closed state despite the open command, that is, the “ON failure” has occurred (#96).

When it is determined in step #55 that the open/close command is the close command (CLOSE), the process proceeds to step #66, and the control unit 2 determines whether or not the fourth deviation ΔV4, which is a difference (absolute value) between the second voltage detection value Vd2 and the fourth reference voltage value Vr4 is equal to or less than the OFF failure determination value To (#66). Since the problem is only a logical operation expression, this is synonymous with determination as to whether or not the fourth deviation ΔV4 exceeds the OFF failure determination value To. Note that in a case where the OFF failure determination value To in step #62 and the OFF failure determination value To in step #66 are distinguished, the OFF failure determination value To in step #62 can be referred to as a first OFF failure determination value (for example, “To1”), and the OFF failure determination value To in step #66 can be referred to as a second OFF failure determination value (for example, “To2”). “To1” and “To2” may be the same value or different values.

As described above, in the first preprocessing #25, the capacitive load 41 is charged with the charge stored in the DC link capacitor 4. Then, since the DC link capacitor 4 is discharged in the second preprocessing #35, when the reverse-flow prevention switch 6 is controlled to be in the closed state, the charge moves from the capacitive load 41 to the DC link capacitor 4. Since the capacitance of the capacitive load 41 is smaller than the capacitance of the DC link capacitor 4, the capacitive load 41 is discharged, and the inter-terminal voltage “V41” becomes substantially zero.

Therefore, the second voltage V2 is also ideally zero, and the fourth reference voltage value Vr4 is also zero. When the reverse-flow prevention switch 6 is normal, the second voltage detection value Vd2, which is the detection value of the second voltage V2, is also zero, so that the second deviation ΔV2 is also zero. That is, step #66 is equivalent to determining whether or not the second voltage V2 is zero. The OFF failure determination value To may be zero, but is preferably set to a value close to zero (for example, about 0.5 to 1 volt) in consideration of a possibility that some leakage current occurs, a possibility that there is a residual charge in the capacitive load 41, a possibility that there is a detection error in the second voltage detection unit 92, and the like.

In a case where the reverse-flow prevention switch 6 is not normal, that is, in a case where the reverse-flow prevention switch 6 has the OFF failure, no current flows from the capacitive load 41 to the DC link capacitor 4. Therefore, the capacitive load 41 is not discharged, the inter-terminal voltage “V41” does not become zero, and the DC link voltage Vdc in the first preprocessing #25 is substantially maintained. Therefore, in a case where the reverse-flow prevention switch 6 has the OFF failure, the determination condition in step #66 is not satisfied.

In a case where the determination condition in step #66 is satisfied, the control unit 2 sets the open/close state (State) of the reverse-flow prevention switch 6 to the closed state (CLOSE) (#77), and in a case where the determination condition in step #66 is not satisfied, the control unit 2 sets the open/close state (State) to the open state (OPEN) (#78). Next, the control unit 2 determines whether or not the open/close command output in step #45 matches the open/close state (State) set in step #77 or step #78 (#86). In a case where the open/close command matches the open/close state (State), the control unit 2 determines that the reverse-flow prevention switch 6 is normal (#97), and in a case where the open/close command does not match the open/close state (State), the control unit 2 determines that the reverse-flow prevention switch 6 is abnormal. In this case, since it is abnormality in a case where the open/close command is the close command, it is determined that an abnormality in which the reverse-flow prevention switch 6 is in the open state despite the close command, that is, the “OFF failure” has occurred (#98).

Incidentally, in a case where the reverse-flow prevention switch 6 is configured by a switching element in which the transistor portion 6s and the diode portion 6d are connected in parallel and the diode portion 6d is connected with the direction from the DC link capacitor 4 side toward the second terminal pair 12 as the forward direction, flow of a current in the direction from the DC link capacitor 4 side toward the second terminal pair 12 is allowed regardless of the control state of the reverse-flow prevention switch 6. Therefore, the control unit 2 can execute the first preprocessing #25 without performing opening/closing control of the reverse-flow prevention switch 6. That is, the control unit 2 can determine whether or not the transistor portion 6s of the reverse-flow prevention switch 6 has the OFF failure by the procedure described above with reference to FIG. 4.

However, in a case where the reverse-flow prevention switch 6 is configured by a switch such as a relay, the OFF failure cannot be determined by a similar procedure without the opening/closing control of the reverse-flow prevention switch 6. For example, if the reverse-flow prevention switch 6 is not controlled to the closed state by the control unit 2, a current cannot flow in a direction from the DC link capacitor 4 toward the second terminal pair 12 in the first preprocessing #25. Therefore, in a case where the reverse-flow prevention switch 6 includes a switch such as a relay, as described above with reference to FIG. 5, the control unit 2 executes the pre-charging processing (#23) after controlling the reverse-flow prevention switch 6 to be in the closed state in step #22 in the first preprocessing #25. As a result, the first preprocessing #25 of operating the power conversion circuit 7 to charge the DC link capacitor 4 is executed in a state where flow of a current from the DC link capacitor 4 to the second terminal pair 12 is allowed when the reverse-flow prevention switch 6 is normal. Then, after the first preprocessing #25, the control unit 2 executes the second preprocessing #35 of controlling the reverse-flow prevention switch 6 to be in the open state, and stopping the operation of the power conversion circuit 7 and discharging the DC link capacitor 4 in a state where flow of a current from the second terminal pair 12 to the DC link capacitor 4 is not allowed when the reverse-flow prevention switch 6 is normal.

At this time, when the switch has the OFF failure, a current does not flow in the direction from the DC link capacitor 4 toward the second terminal pair 12 in the first preprocessing #25, and the inter-terminal voltage “V41” of the capacitive load 41, that is, the second voltage V2 is substantially zero. When the processing in step #45 and subsequent steps is continued and the OFF failure determination processing #30 is executed, it is determined in step #66 that the reverse-flow prevention switch 6 is in the closed state, and “State =CLOSE” is set in step #77. Then, in subsequent step #86, it is determined that the open/close command in the OFF failure determination processing #30 and “State” match, and the determination result of the OFF failure determination processing #30 becomes “normal” (#97). That is, the occurrence of the OFF failure cannot be detected. Note that in a case where the ON failure determination processing #20 is executed, it is determined in step #65 that the reverse-flow prevention switch 6 is in the closed state, and the determination result of the ON failure determination processing #20 is the ON failure indicating an abnormality (#96). It is determined that the reverse-flow prevention switch 6 is not normal and an abnormality has occurred, but the type of the abnormality is erroneously determined.

In addition, not only in a case where the reverse-flow prevention switch 6 is configured by a switch such as a relay, but also in a case where the reverse-flow prevention switch 6 is configured by a switching element, in the procedure described above with reference to FIGS. 4 and 5, in a case where the diode portion 6d fails, it may not be possible to determine failure in which the reverse-flow prevention switch 6 does not enter a state of passing a current. As described above, it is at least determined that an abnormality has occurred, but the type of the abnormality cannot be accurately determined. Note that in a case where a failure in which the diode portion 6d of the switching element is normal and only the transistor portion 6s does not enter a state of passing a current (OFF failure to be determined above) and a failure in which the diode portion 6d also does not enter a state of passing a current according to the specification are distinguished, the latter is referred to as the “open failure”. The “open failure” can be referred to as a special mode in the “OFF failure”. In a case where a failure has occurred in the diode portion 6d, a failure also occurs in the transistor portion 6s due to the structure of the switching element. Therefore, the “open failure” can be said to be a failure in which both the diode portion 6d and the transistor portion 6s do not enter a state of passing a current according to the specification regardless of the current flowing direction and the control state. Note that in the present embodiment, a failure in which at least the diode portion 6d does not enter a state of passing a current according to the specification is also included in the “open failure”.

Therefore, in the first preprocessing #25, the control unit 2 preferably executes determination processing (pre-failure determination processing #24 in FIG. 6) similar to that in step #65 (in FIGS. 4 and 6, “Yes” branch destinations are reverse, that is, “normal” and “failure”, respectively, and thus the determination logic expressions are also in reverse logic). That is, in the first preprocessing #25, it is preferable to check that the inter-terminal voltage (DC link voltage Vdc) of the DC link capacitor 4 and the inter-terminal voltage “V41” (second voltage V2) of the capacitive load 41 are substantially the same (in a case where the chopper circuit 3 is in a direct-coupled operation state and the forward voltage drop of the diode portion 6d is ignored). For this determination, a fifth reference voltage value Vr5 corresponding to the second reference voltage value Vr2 in step #65 and the second voltage detection value Vd2 may be used, or the first voltage detection value Vd1 and the second voltage detection value Vd2 may be used. The fifth reference voltage value Vr5 is a value corresponding to the DC link voltage Vdc (first voltage detection value Vd1), which is the inter-terminal voltage of the DC link capacitor 4 in the pre-charging processing #23. In a case where the chopper circuit 3 is in the direct-coupled operation state, the fifth reference voltage value Vr5 can be substantially the DC link voltage Vdc (first voltage detection value Vd1) when the forward voltage drop of the diode portion 6d is ignored. In a case where the chopper circuit 3 performs a step-down operation, the fifth reference voltage value Vr5 can be a voltage of a step-down command to the chopper circuit 3.

For example, in a case where a fifth deviation ΔV5, which is the difference (absolute value) between the fifth reference voltage value Vr5 (or the first voltage detection value Vd1) and the second voltage detection value Vd2, exceeds a pre-failure determination value Tp, the control unit 2 determines that a failure (OFF failure or open failure) in which the reverse-flow prevention switch 6 does not enter a state of passing a current has occurred (FIG. 6: #24→#28, #29). As described above, since the open failure can also be referred to as a special mode of the OFF failure, step #28 may be referred to as the “OFF failure (open failure)”. Although the pre-failure determination value Tp may be zero, similarly to the second reference voltage value Vr2, it is preferable that the pre-failure determination value Tp is set to a value close to zero (for example, about 1 to 2 volts) in consideration of a voltage drop due to the wiring resistance and the circuit elements (the diode and the choke coil 33), an error in the time constant, a detection error of the first voltage detection unit 91, and the like.

Note that when the second diagnosis processing #15 is executed, the capacitive load 41 not connected to the power storage device is discharged, and the inter-terminal voltage “V41”, that is, the second voltage V2 is substantially zero. In a case where a failure (OFF failure or open failure) has occurred in the reverse-flow prevention switch 6 in a state of interrupting the current flowing toward the second terminal pair 12, the second voltage V2 does not rise and is substantially zero even if the first preprocessing #25 is executed. Therefore, in the pre-failure determination processing #24, the control unit 2 may determine that a failure has occurred in a case where the second voltage V2 is substantially zero.

FIG. 6 illustrates a flowchart in which the pre-failure determination processing #24 is added to the flowchart in FIG. 5. Although the determination content is the same, since the determination result in the case of failure varies depending on whether the reverse-flow prevention switch 6 is a switching element or a switch such as a relay, two steps of “#24a” and “#24b” are provided. Along with this, two steps of “#23a” and “#23b” are provided for the pre-charging processing #23. That is, the first preprocessing #25 including the pre-failure determination processing #24 includes two systems, that is, a system that proceeds to steps #23a (#23) and #24a (#24) after step #21 and a system that proceeds to steps #23b (#23) and #24b (#24) after step #21.

In a case where it is not determined that a failure has occurred in the pre-failure determination processing #24, the control unit 2 determines that the first preprocessing #25 has succeeded, and proceeds to step #35. That is, in a case where the reverse-flow prevention switch 6 is configured by a switching element, it is possible to determine whether or not the transistor portion 6s has the OFF failure by executing the OFF failure determination processing #30 in step #45 and subsequent steps. In a case where the reverse-flow prevention switch 6 is configured by a switch, it can be checked in the pre-failure determination processing #24 that the OFF failure has not occurred, and thus the OFF failure determination processing #30 may not be executed.

In a case where it is determined in the pre-failure determination processing #24 that the OFF failure has occurred (#23b→#24b→#29), the process proceeds to $2, and the control unit 2 ends the diagnosis processing #10. That is, in a case where the reverse-flow prevention switch 6 is configured by a switch, the diagnosis processing #10 ends here. In a case where it is determined in the pre-failure determination processing #24 that the open failure has occurred (#23b→#24b→#29), it is found that a failure has occurred at least in the diode portion 6d. In general, there is almost no case where only the diode portion 6d fails and the transistor portion 6s is normal due to the structure of the switching element, and if a failure occurs in the diode portion 6d, there is an abnormality in the switching element. Therefore, the process may end here as in a case where the reverse-flow prevention switch 6 is configured by a switch.

In a case where it is desired to more clearly determine the presence or absence of the failure of the transistor portion 6s, although not illustrated, for example, the control unit 2 can determine whether or not the OFF failure has also occurred in the transistor portion 6s by regarding the switching element in which the failure has occurred in the diode portion 6d as a switch and executing the same processing as “#22→#23b→#24b” of the first preprocessing #25 (assumed to be “#22c→#23c→#24c”) after step #29. Here, in a case where it is determined to be normal (in a case where the determination result of step #24c is “No”), the transistor portion 6s is normal. Therefore, the control unit 2 can determine that it is a failure in which only the diode portion 6d does not enter a state of passing a current. In a case where the determination result of step #24c is “Yes”, the control unit 2 can determine that it is a failure in which both the diode portion 6d and the transistor portion 6s do not enter a state of passing a current.

That is, in the power conversion unit 1 including the capacitive load 41 connected to the second terminal pair 12, in a state where the power storage device (low-voltage battery BL) is not connected to the second terminal pair 12 (step #1→No: $1), the control unit 2 may perform the diagnosis processing #10 as follows. The control unit 2 executes the first preprocessing #25 including the pre-charging processing #23 of operating the power conversion circuit 7 to charge the DC link capacitor 4 in a state where flow of a current from the DC link capacitor 4 to the second terminal pair 12 is allowed when the reverse-flow prevention switch 6 is normal, and the pre-failure determination processing #24 executed after the pre-charging processing #23. In the pre-failure determination processing #24, in a case where a difference (for example, the fifth deviation ΔV5) between the fifth reference voltage value Vr5 corresponding to the inter-terminal voltage(DC link voltage Vdc) of the DC link capacitor 4 and the second voltage detection value Vd2 in the pre-charging processing #23 exceeds the pre-failure determination value Tp, it is determined that the OFF failure has occurred. Following the first preprocessing #25, the control unit 2 executes the second preprocessing #35 of stopping the operation of the power conversion circuit 7 and discharging the DC link capacitor 4 in a state of not allowing flow of a current from the second terminal pair 12 to the DC link capacitor 4 when the reverse-flow prevention switch 6 is normal. Then, in the ON failure determination processing #20, the control unit 2 performs determination processing (#65) using a value corresponding to the inter-terminal voltage (DC link voltage Vdc) of the DC link capacitor 4 in the pre-charging processing #23 as the second reference voltage value Vr2, and in the OFF failure determination processing #30, the control unit 2 performs determination processing (#66) using a value corresponding to the inter-terminal voltage “V41” of the capacitive load 41 in a discharge completion state as the fourth reference voltage value Vr4.

Note that in the above description, a mode in which the ON failure and the OFF failure are determined separately has been exemplified. However, a mode in which in a case where any one of the ON failure and the OFF failure has occurred, it is determined that “abnormality” has occurred in the reverse-flow prevention switch 6 without distinguishing the ON failure and the OFF failure is also possible. That is, a mode in which in a case where it is determined as “abnormal (ON failure or OFF failure)” in the determination result of either the ON failure determination processing #20 or the OFF failure determination processing #30, it is determined that “abnormality has occurred in the reverse-flow prevention switch 6” is also possible. In such a mode, the pre-failure determination processing #24 may not be executed in the second diagnosis processing #15.

In the above description, the case where the low-voltage battery BL is applied as the power storage device has been described as an example, but the high-voltage battery BH can also be applied as the power storage device. The detailed description thereof will be omitted because those skilled in the art can easily understand it.

<1> As one aspect, a power conversion unit (1) includes:
a first terminal pair (11) that is connected to a DC terminal pair (77) of a power conversion circuit (7);
a second terminal pair (12) that is connected to a power storage device (BL);
a DC link capacitor (4) that is connected to both ends of the first terminal pair (11);
a reverse-flow prevention switch (6) that is disposed between the first terminal pair (11) and the second terminal pair (12), allows a current to flow between the first terminal pair (11) and the second terminal pair (12) in a closed state, and interrupts at least a current flowing from the second terminal pair (12) to the first terminal pair (11) in an open state;
a first voltage detection unit (91) that detects an inter-terminal voltage (V1) of the first terminal pair (11);
a second voltage detection unit (92) that detects an inter-terminal voltage (V2) of the second terminal pair (12); and
a control unit (2) that controls the power conversion circuit (7) and the reverse-flow prevention switch (6),
the control unit (2) is able to execute diagnosis processing (#10) of determining whether the reverse-flow prevention switch (6) is normal or abnormal,
in the diagnosis processing (#10), the control unit (2) executes at least one of ON failure determination processing (#20) of determining whether an ON failure in which the reverse-flow prevention switch (6) is in the closed state has occurred or an OFF failure determination processing (#30) of determining whether an OFF failure in which the reverse-flow prevention switch (6) is in the open state has occurred,
in the ON failure determination processing (#20),
the control unit (2) controls the reverse-flow prevention switch (6) to be in the open state, and
the control unit (2) determines that the ON failure has occurred in a case where any one of a difference (first deviation ΔV1) between a first reference voltage value (Vr1), which is the inter-terminal voltage (V1) of the first terminal pair (11) in a case where the reverse-flow prevention switch (6) is in the open state and the reverse-flow prevention switch (6) is normal, and a first voltage detection value (Vd1), which is a detection value of the first voltage detection unit (91), and a difference (second deviation ΔV2) between a second reference voltage value (Vr2), which is the inter-terminal voltage (V2) of the second terminal pair (12) in a case where the reverse-flow prevention switch (6) is in the open state and the reverse-flow prevention switch (6) is normal and a second voltage detection value (Vd2), which is a detection value of the second voltage detection unit (92), exceeds an ON failure determination value (Ts) that is set in advance, and
in the OFF failure determination processing (#30),
the control unit (2) controls the reverse-flow prevention switch (6) to be in the closed state, and
the control unit (2) determines that the OFF failure has occurred in a case where any one of a difference (third deviation ΔV3) between a third reference voltage value (Vr3) and the first voltage detection value (Vd1), the third reference voltage value (Vr3) being the inter-terminal voltage (V1) of the first terminal pair (11) in a case where the reverse-flow prevention switch (6) is in the closed state and the reverse-flow prevention switch (6) is normal, and a difference (fourth deviation ΔV4) between a fourth reference voltage value (Vr4) and the second voltage detection value (Vd2), the fourth reference voltage value (Vr4) being the inter-terminal voltage (V2) of the second terminal pair (12) in a case where the reverse-flow prevention switch (6) is in the closed state and the reverse-flow prevention switch (6) is normal, exceeds an OFF failure determination value (To) that is set in advance.

In other words,
a power conversion unit includes:
a first terminal pair that is connected to a DC terminal pair of a power conversion circuit;
a second terminal pair that is connected to a power storage device;
a DC link capacitor that is connected to both ends of the first terminal pair;
a reverse-flow prevention switch that is disposed between the first terminal pair and the second terminal pair, allows a current to flow between the first terminal pair and the second terminal pair in a closed state, and interrupts at least a current flowing from the second terminal pair to the first terminal pair in an open state;
a first voltage detection unit that detects an inter-terminal voltage of the first terminal pair;
a second voltage detection unit that detects an inter-terminal voltage of the second terminal pair; and
a control unit that controls the power conversion circuit and the reverse-flow prevention switch,
the control unit is able to execute diagnosis processing of determining whether the reverse-flow prevention switch is normal or abnormal,
in the diagnosis processing, the control unit executes at least one of ON failure determination processing of determining whether an ON failure in which the reverse-flow prevention switch is in the closed state has occurred or OFF failure determination processing of determining whether an OFF failure in which the reverse-flow prevention switch is in the open state has occurred,
in the ON failure determination processing,
the control unit controls the reverse-flow prevention switch to be in the open state, and
the control unit determines that the ON failure has occurred in a case where any one of a difference between a first reference voltage value, which is the inter-terminal voltage of the first terminal pair in a case where the reverse-flow prevention switch is in the open state and the reverse-flow prevention switch is normal, and a first voltage detection value, which is a detection value of the first voltage detection unit, and a difference between a second reference voltage value, which is the inter-terminal voltage of the second terminal pair in a case where the reverse-flow prevention switch is in the open state and the reverse-flow prevention switch is normal, and a second voltage detection value, which is a detection value of the second voltage detection unit, exceeds an ON failure determination value that is set in advance, and
in the OFF failure determination processing,
the control unit controls the reverse-flow prevention switch to be in the closed state, and
the control unit determines that the OFF failure has occurred in a case where any one of a difference between a third reference voltage value and the first voltage detection value, the third reference voltage value being the inter-terminal voltage of the first terminal pair in a case where the reverse-flow prevention switch is in the closed state and the reverse-flow prevention switch is normal, and a difference between a fourth reference voltage value and the second voltage detection value, the fourth reference voltage value being the inter-terminal voltage of the second terminal pair in a case where the reverse-flow prevention switch is in the closed state and the reverse-flow prevention switch is normal, exceeds an OFF failure determination value that is set in advance.

According to this configuration, it is possible to execute the diagnosis processing (#10) of appropriately determining whether the reverse-flow prevention switch (6) is normal or abnormal by using the reference voltage values (Vr1, Vr2) based on the inter-terminal voltage (V1) of the first terminal pair (11) and the inter-terminal voltage (V2) of the second terminal pair (12) in a case where the reverse-flow prevention switch (6) is normal, and the voltage detection values (Vr1, Vr2) of the first terminal pair (11) and the second terminal pair (12). Abnormality in the reverse-flow prevention switch (6) includes the ON failure and the OFF failure. Either of the failures can be determined to be abnormal.

In other words, according to this configuration, it is possible to execute the diagnosis processing of appropriately determining whether the reverse-flow prevention switch is normal or abnormal by using the reference voltage values based on the inter-terminal voltage of the first terminal pair and the inter-terminal voltage of the second terminal pair in a case where the reverse-flow prevention switch is normal, and the voltage detection values of the first terminal pair and the second terminal pair. Abnormality in the reverse-flow prevention switch includes the ON failure and the OFF failure. Either of the failures can be determined to be abnormal. As described above, according to the present configuration, it is possible to provide a technique for determining whether or not there is an abnormality in a switch capable of electrically connecting and disconnecting a power conversion circuit and a power storage device in a power conversion unit including the switch.

<2> In addition, as one aspect, in the power conversion unit (1), it is preferable that in a case where the control unit (2) performs the diagnosis processing (#10) from a state in which the power storage device (BL) is connected to the second terminal pair (12) and discharge of the DC link capacitor (4) is completed,
in the ON failure determination processing (#20), a value corresponding to an inter-terminal voltage (Vdc) of the DC link capacitor (4) in a discharge completion state is set as the first reference voltage value (Vr1), and
in the OFF failure determination processing (#30), a value corresponding to the inter-terminal voltage (Vdc) of the DC link capacitor (4) charged by charge from the power storage device (BL) is set as the third reference voltage value (Vr3).

In other words, in the power conversion unit, in a case where the control unit performs the diagnosis processing from a state in which the power storage device is connected to the second terminal pair and discharge of the DC link capacitor is completed,
in the ON failure determination processing, a value corresponding to an inter-terminal voltage of the DC link capacitor in a discharge completion state is set as the first reference voltage value, and
in the OFF failure determination processing, a value corresponding to the inter-terminal voltage of the DC link capacitor charged by charge from the power storage device is set as the third reference voltage value.

According to this configuration, in a state where the power storage device (BL) is connected to the power conversion unit (1), it is possible to execute the diagnosis processing of appropriately determining whether the reverse-flow prevention switch (6) is normal or abnormal even in a case where either the ON failure or the OFF failure has occurred by using the relationships between the first voltage detection value (Vd1) and each of the first reference voltage value (Vr1) and the third reference voltage value (Vr3) based on the inter-terminal voltage of the first terminal pair (11) in a case where the reverse-flow prevention switch (6) is normal.

<3> In addition, as one aspect, it is preferable that the power conversion unit (1) further includes a capacitive load (41) that is connected to the second terminal pair (12),
in a case where the control unit (2) performs the diagnosis processing (#10) in a state where the power storage device (BL) is not connected to the second terminal pair (12),
after the control unit (2) executes first preprocessing (#25) of operating the power conversion circuit (7) to charge the DC link capacitor (4) in a state where flow of a current from the DC link capacitor (4) to the second terminal pair (12) is allowed when the reverse-flow prevention switch (6) is normal,
the control unit (2) executes second preprocessing (#35) of stopping operation of the power conversion circuit (7) and discharging the DC link capacitor (4) in a state where flow of a current from the second terminal pair (12) to the DC link capacitor (4) is not allowed when the reverse-flow prevention switch (6) is normal,
in the ON failure determination processing (#20), a value corresponding to an inter-terminal voltage (Vdc) of the DC link capacitor (4) in the first preprocessing (#25) is set as the second reference voltage value (Vr2), and
in the OFF failure determination processing (#30), a value corresponding to an inter-terminal voltage (V41) of the capacitive load (41) in a discharge completion state is set as the fourth reference voltage value (Vr4).

In other words, the power conversion unit further includes a capacitive load that is connected to the second terminal pair,
in a case where the control unit performs the diagnosis processing in a state where the power storage device is not connected to the second terminal pair,
after the control unit executes first preprocessing of operating the power conversion circuit to charge the DC link capacitor in a state where flow of a current from the DC link capacitor to the second terminal pair is allowed when the reverse-flow prevention switch is normal,
the control unit executes second preprocessing of stopping operation of the power conversion circuit and discharging the DC link capacitor in a state where flow of a current from the second terminal pair to the DC link capacitor is not allowed when the reverse-flow prevention switch is normal,
in the ON failure determination processing, a value corresponding to an inter-terminal voltage of the DC link capacitor in the first preprocessing is set as the second reference voltage value, and
in the OFF failure determination processing, a value corresponding to an inter-terminal voltage of the capacitive load in a discharge completion state is set as the fourth reference voltage value.

According to this configuration, in a state where the DC link capacitor (4) and the second terminal pair (12) are electrically connected through the reverse-flow prevention switch (6), the inter-terminal voltage (Vdc) of the DC link capacitor (4) and the inter-terminal voltage (V2) of the second terminal pair (12) have substantially the same value. In this state, for example, the inter-terminal voltage (Vdc) of the DC link capacitor (4) and the inter-terminal voltage (V2) of the second terminal pair (12) in the first preprocessing (#25) have substantially the same value. Therefore according to this configuration, in a state where the power storage device (BL) is not connected to the power conversion unit (1), it is possible to execute the diagnosis processing of appropriately determining whether the reverse-flow prevention switch (6) is normal or abnormal even in a case where either the ON failure or the OFF failure has occurred by using the relationships between the second voltage detection value (Vd2) and each of the second reference voltage value (Vr2) and the fourth reference voltage value (Vr4) based on the inter-terminal voltage of the second terminal pair (12) in a case where the reverse-flow prevention switch (6) is normal.

<4> In addition, as one aspect, in the power conversion unit (1), it is preferable that at least a plurality (61, 62) of the reverse-flow prevention switches (6) are connected in parallel and at least one temperature sensor (66) that detects temperature of the plurality of reverse-flow prevention switches (6(61, 62)) is provided.

In other words, a plurality of the reverse-flow prevention switches are connected in parallel, and
at least one temperature sensor that detects temperature of the plurality of reverse-flow prevention switches is provided.

According to this configuration, in a case where any one of the two reverse-flow prevention switches (61,62) fails, a current flows through the other. As a result, the temperature of the reverse-flow prevention switch through which a current flows easily rises. When the temperature sensor (66) detects that the temperature of the reverse-flow prevention switch (6) is higher than the specified temperature, it is possible to detect that any one of the reverse-flow prevention switches (6) has failed.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A power conversion unit comprising:
a first terminal pair that is connected to a DC terminal pair of a power conversion circuit;
a second terminal pair that is connected to a power storage device;
a DC link capacitor that is connected to both ends of the first terminal pair;
a reverse-flow prevention switch that is disposed between the first terminal pair and the second terminal pair, allows a current to flow between the first terminal pair and the second terminal pair in a closed state, and interrupts at least a current flowing from the second terminal pair to the first terminal pair in an open state;
a first voltage detection unit that detects an inter-terminal voltage of the first terminal pair;
a second voltage detection unit that detects an inter-terminal voltage of the second terminal pair; and
a control unit that controls the power conversion circuit and the reverse-flow prevention switch,
wherein the control unit is able to execute diagnosis processing of determining whether the reverse-flow prevention switch is normal or abnormal,
in the diagnosis processing, the control unit executes at least one of ON failure determination processing of determining whether an ON failure in which the reverse-flow prevention switch is in the closed state has occurred or OFF failure determination processing of determining whether an OFF failure in which the reverse-flow prevention switch is in the open state has occurred,
in the ON failure determination processing,
the control unit controls the reverse-flow prevention switch to be in the open state, and
the control unit determines that the ON failure has occurred in a case where any one of a difference between a first reference voltage value, which is the inter-terminal voltage of the first terminal pair in a case where the reverse-flow prevention switch is in the open state and the reverse-flow prevention switch is normal, and a first voltage detection value, which is a detection value of the first voltage detection unit, and a difference between a second reference voltage value, which is the inter-terminal voltage of the second terminal pair in a case where the reverse-flow prevention switch is in the open state and the reverse-flow prevention switch is normal, and a second voltage detection value, which is a detection value of the second voltage detection unit, exceeds an ON failure determination value that is set in advance, and
in the OFF failure determination processing,
the control unit controls the reverse-flow prevention switch to be in the closed state, and
the control unit determines that the OFF failure has occurred in a case where any one of a difference between a third reference voltage value and the first voltage detection value, the third reference voltage value being the inter-terminal voltage of the first terminal pair in a case where the reverse-flow prevention switch is in the closed state and the reverse-flow prevention switch is normal, and a difference between a fourth reference voltage value and the second voltage detection value, the fourth reference voltage value being the inter-terminal voltage of the second terminal pair in a case where the reverse-flow prevention switch is in the closed state and the reverse-flow prevention switch is normal, exceeds an OFF failure determination value that is set in advance.

2. The power conversion unit according to claim 1,
wherein in a case where the control unit performs the diagnosis processing from a state in which the power storage device is connected to the second terminal pair and discharge of the DC link capacitor is completed,
in the ON failure determination processing, a value corresponding to an inter-terminal voltage of the DC link capacitor in a discharge completion state is set as the first reference voltage value, and
in the OFF failure determination processing, a value corresponding to the inter-terminal voltage of the DC link capacitor charged by charge from the power storage device is set as the third reference voltage value.

3. The power conversion unit according to claim 1 further comprising:
a capacitive load that is connected to the second terminal pair,
wherein in a case where the control unit performs the diagnosis processing in a state where the power storage device is not connected to the second terminal pair,
after the control unit executes first preprocessing of operating the power conversion circuit to charge the DC link capacitor in a state where flow of a current from the DC link capacitor to the second terminal pair is allowed when the reverse-flow prevention switch is normal,
the control unit executes second preprocessing of stopping operation of the power conversion circuit and discharging the DC link capacitor in a state where flow of a current from the second terminal pair to the DC link capacitor is not allowed when the reverse-flow prevention switch is normal,
in the ON failure determination processing, a value corresponding to an inter-terminal voltage of the DC link capacitor in the first preprocessing is set as the second reference voltage value, and
in the OFF failure determination processing, a value corresponding to an inter-terminal voltage of the capacitive load in a discharge completion state is set as the fourth reference voltage value.

4. The power conversion unit according to claim 1,
wherein a plurality of the reverse-flow prevention switches are connected in parallel, and
at least one temperature sensor that detects temperature of the plurality of reverse-flow prevention switches is provided.

5. The power conversion unit according to claim 2,
wherein a plurality of the reverse-flow prevention switches are connected in parallel, and
at least one temperature sensor that detects temperature of the plurality of reverse-flow prevention switches is provided.

6. The power conversion unit according to claim 3,
wherein a plurality of the reverse-flow prevention switches are connected in parallel, and
at least one temperature sensor that detects temperature of the plurality of reverse-flow prevention switches is provided.
